(19) United States
(12) Patent Application Publication
(10) Pub. No.: US 2006/0138316 A1
(43) Pub. Date: Jun. 29, 2006

(54) Time-of-flight mass spectrometer

(76) Inventors: Robert Seydoux, Uster (CH); Urs Matter, Solothum (CH); Lothar Schultheis, Ottringjen (DE)

Correspondence Address: REISING, ETHINGTON, BARNES, KISSELLE, P.C., P O BOX 4390, TROY, MI, 48099-4390, US

(21) Appl. No.: 10/543,329

(22) PCT Filed: Jan. 28, 2003
(86) PCT No.: PCT/CH03/00069

§ 371 Date: Jul. 25, 2005

(51) Int. Cl. B01D 59/44

(52) U.S. Cl. 250/282; 250/287

(57) ABSTRACT

Time-of-flight mass spectrometer (1), comprising an extractor module (3) for accelerating ionized substances by means of an electric field and for focusing the ionized substance onto a focusing axis (6) by means of at least one ion lens (32), a deflector (4) for deflecting the ionized substances, a drift path (7) as well as a detector (5) for detecting the ionized substance, the extractor module (3) being displaceably disposed relative to the detector (5), and the focusing axis being centered, in a first position, on the detector surface (51), while the focusing axis (6), in a second position, is positioned outside the detector surface (51). The invention allows in particular the spectra of neutral and charged particles to be measured independently from one another.

The present invention relates to a time-of-flight (ToF) mass spectrometer, comprising, for analyzing substances from an ion source, an extractor module for accelerating the ionized substances by means of an electromagnetic field and for focusing the ionized substances on a focusing axis, a deflector for deflecting the ionized substances, at least one field-free drift path as well as a detector for detecting the ionized substances. In particular, with the invention, the spectra of neutral and charged particles should be measured independently of one another.

Very diverse analytical mass spectrometers are known in the state of the art. The mode of operation of a mass spectrometer (MS) is usually based on the specimen being positioned in the MS, vaporized and ionized. As moving charged particles, the ions allow themselves to be separated in an analyzer in various ways according to their mass-to-charge ratio, and subsequently detected. The installation of an MS may be divided up into four main components: sample taking, ionization, mass separation and detection. Generally used are instruments based on sequentially operating mass spectrometers according to the ToF, quadrupole, ion trap or sector field principles. The technical achievement of sample taking, ionization and detection is comparable with all mass spectrometers. Ion traps differ from the other mass spectrometers, however, in that involved is a storage mass spectrometer with ionization in the ion trap. Sample taking in the mass spectrometer takes place according to the characteristics of the specimen. Solid specimen substances can be introduced directly into the ion source e.g. via a push rod or holding rod. Suitable for liquid or gaseous specimens is the coupling with a gas chromatograph (GC) or high performance (high pressure) liquid chromatograph (HPLC). The essential difference consists in the analyzer systems which are responsible for the mass separation.

Mass spectrometers also include so-called time-of-flight mass spectrometers (ToF-MS). Conventional time-of-flight mass spectrometers are sufficiently known and described in the state of the art (Michael Guilhaus: Journal of Mass Spectrometry, Vol. 30, 1519-1532 (1995), “Principles and Instrumentation in Time-Of-Flight Mass Spectrometry”; Duckworth et al.: Mass Spectroscopy, 2^{nd} Ed., Cambridge University Press, Cambridge (1986); A. M. Lawson, Mass Spectrometry, Walter de Gruyter, Berlin (1989); S. R. Shrader, Introductory Mass Spectrometry, Ally & Bacon, Inc. Boston (1971); G. Siuzdak, Mass Spectrometry for Biotechnology, Academic Press, San Diego (1996); J. T. Watson, Introduction to Mass Spectrometry, Raven Press, New York (1985), etc.). Until now the analytical use of time-of-flight mass spectrometers has been limited predominantly to the analysis of pulse-shaped ion signals, e.g. from laser vaporization sources (LAMMA: Laser Desorption Mass Spectrometer). However, also known is the coupling of a continuously emitting atomic beam source with a ToF-MS using a storage repository (e.g. DE 4022061.3). This spectrometer type has been limited until today to pulse-shaped ion pulses, however, such as e.g. during laser vaporization, without storage of the ions to be detected prior to their introduction into the ToF-MS. Use of ToF-MS for elemental and molecular analysis is advantageous in particular owing to the possibility of a simultaneous measurement of all masses concerned. In contrast, quadrupole or sector field systems have drawbacks owing to the increased measuring time having to do with larger sample needs.

With time-of-flight mass spectrometers, ions formed in a pulse-type way of the analyte substance to be analyzed are accelerated in an ion source in a very short time span of just a few nanoseconds in relatively short accelerations fields to the same energy per ion charge. This means that all ions with the same number of elementary charges z have the same kinetic energy Eₖᵢₙ(z). The ions then fly through a field-free flight path, and are measured at its end by a temporally <sic.> high resolution ion detector as temporally varying ion current. By means of the measuring signals of the ion detector, the time of flight of the different types of ions are determined. Via the basic equation for kinetic energy:

$${E}_{kin} = \frac{1}{2} mv = zeU = zeEd \qquad ( i )$$

with the same energy E for all ions, the ratio m/z of mass m to charge z of the ions can be determined from their velocity. U is the difference of potential of the accelerating electrode to the earthed electrode, E is the electrical field between the two electrodes, and d the distance between the two electrodes. As indicated above, in a flight tube of length L, the velocity v of the ions is given by measurement of the time of flight t of the ions through the equation

$$v = L / t = \sqrt{\frac{2 ezU}{M}} \qquad ( ii )$$

The ratio of the mass m to the charge z can thus be calculated in a simple way from the time of flight:

$$m / z = \frac{- 2 {Et}^{2}}{{L}^{2}} \qquad ( iii )$$

The equations indicated above are not sufficient for a very precise determination of the ion mass since 1) initial energies from the ionization process are unavoidably imparted to the ions in the ion source through the ionization process prior to their electrical acceleration, and 2) the three-dimensional trajectory of the ions is no longer described through L alone. Through these effects the relation between mass m and the square of the time of flight t becomes non-linear. This relation is therefore normally determined experimentally, and is stored in a computer memory as the so-called “mass scale” for future determinations of the mass. Understood here by the term “mass scale” should be the correlation, made by a connected computer system, of the times of flight, determined from the measurement signals, to the masses of the ions (more precisely: the mass-to-charge ratios). This mass scale is calibrated by a special method on the basis of precisely known reference substances. A large number of parameters influence in general the stability of the calibrated mass scale: instability of the high voltages for the acceleration of the ions, changing spacing apart of the acceleration apertures in the ion source through the installation of the sample carriers introduced into the vacuum, changing initial energies of the ions owing to the ionization process and thermal changes in the length of the flight paths, etc. For high precision measurements of the masses of an analyte substance, therefore, the mass of a reference substance is co-measured in the same mass spectrum, the reference substance having to be added to the analyte substance (so-called measuring method with “internal reference”). With deviations in the calculated mass of the reference substance from the known value, the calculated mass for the analyte ions can then be corrected in a known way (e.g. DE 196 35 646). Unfortunately the various influences upon the mass determination enter in, however, in the different functional dependencies of the mass. Changes in the high voltage, for example, bring about a proportional change in the energy Eₖᵢₙ of the ions, which, according to equation (iii) goes into the linearly, i.e. mass proportionally. Changes in the flight length L enter into the mass calculation, according to equation (iii), proportionally to the root from the mass, however. If reference mass and analyte mass are very different, a successful correction is then no longer possible without precise information about the type of influence. With very similar masses for analyte and reference substance, correction can still be made with reasonably good success. Mass precisions of about 30 parts per million (ppm) are obtained today with high performance time-of-flight mass spectrometers using reference to reference substances which are not contained in the analyte sample (“method with external reference”). Using reference substances that are added to the analyte sample (“internal reference”), precisions of 10 ppm are achieved. For protein chemists and other users, mass precisions of 1 to 5 ppm are aimed at today, in order to obtain the measuring values required for research.

Very diverse methods are known in the state of the art for generating ionized molecules from solid, liquid, or gaseous substances: thermal ionization (e.g. of a gas or a vapor), spark source ionization (spark source), electron impact (EI), photoionization (PI), chemical ionization (CI), field ionization (FI), field desorption (FD), multiphoton ionization (MPI), ionization through bombardment of fast atoms (fast atom bombardment: FAB), plasma desorption mass spectrometry (PDMS), secondary ion mass spectrometry (SIMS), thermospray method (TS), infrared laser desorption (IRLD), matrix-assisted laser desorption (MALDI), electrospray ionization (ESI), nanoelectrospray ionization (NESI), chemical ionization with normal pressure (atmospheric pressure chemical ionization: APCI), etc. The most important parameters in ion generation are the spatial distribution and the velocity distribution as well as the mass/charge distribution of the various ionized molecules, which greatly influences the performance of the mass spectrometer components following therefrom. One of the most commonly used methods for ion generation in time-of-flight spectrometry is ionization through laser-induced desorption. The sample carrier with substance molecules is thereby put constantly at a high voltage of e.g. 6 to 30 kilovolts, and arranged at a distance of about e.g. 10 to 20 millimeters from an opposite base electrode at earth potential. A light pulse of a laser, of typically about 4 nanoseconds in duration, which is focused on the sample surface, generates ions of the substance molecules which leave the surface with a great dispersion of velocities and are immediately accelerated through the electrical field toward the base electrode. Located on the other side of the base electrode is the field-free drift path of the time-of-flight mass spectrometer. For ionization of the substance molecules through matrix-assisted laser desorption (MALDI), the substance molecules on the sample carrier are incorporated into a layer of tiny crystals of a low molecular matrix substance. In a quasi-explosive process, the laser light pulse vaporizes a minimal amount of matrix substance, the substance molecules also being carried over into the vapor cloud. With the formation of the vapor cloud, a minimal portion of the molecules ionizes, and to be precise, of both the matrix molecules and of the substance molecules. Also during the expansion of the vapor cloud a constant ionization takes place of the larger substance molecules at the cost of the smaller matrix ions through further ion-molecule reactions. Through its adiabatic expansion, the vapor cloud expanding into the vacuum accelerates not only the molecules and ions of the matrix substance, but also, through viscous entrainment, the molecules and ions of the analyte substance. If the cloud expands into the field-free space, the ions thus reach mid-range velocities, which are largely independent of the mass of the ions, but have a large velocity dispersion. It is to be assumed that the neutral molecules have velocities similar to, or the same as, the ions.

The great dispersion of velocities with the various laser-induced ionizations impairs and limits the mass resolution of the time-of-flight mass spectrometers. Even with use of high acceleration voltages, which leaves the dispersion of the initial velocities relative to the mid-range velocity minimal, the resolution of linear time-of-flight spectrometers is limited to values of about R=m/Δm=1000 with m=1000, and limits precision of mass measurements to 0.1%. The basic principle for improvement of mass resolution with such methods for velocity dispersion has been known already for a long time (W. C. Wiley and I. H. McLaren, “Time-of-Flight Mass Spectrometer with Improved Resolution” Rev. Scient. Instr. 26, 1150,1955). This method is known by the name of time lag focusing (TLF). Most recently this method has also become known by other name, such as e.g. “delayed extraction” in scientific works with reference to MALDI ionization, and is already offered for commercially available time-of-flight mass spectrometers. Mentioned as the state of the art may be newer publications such as, for instance, R. S. Brown and J. J. Lennon, “Mass Resolution Improvement by Incorporation of Pulsed Ion Extraction in a Matrix-Assisted Laser Desorption/lonization Linear Time-of-Flight Mass Spectrometer,” Anal. Chem 67, 1998, (1995) or R. M. Whittal and L. Li, “High-Resolution Matrix-Assisted Laser Desorption/Ionization in a Linear Time-of Flight Mass Spectrometer,” 67, 1950, (1995).

The principle of time lag focusing for improvement of resolution is simple: the ions of the extraction cloud are allowed to fly initially in a field-free space for a short time without any electrical acceleration. The faster ions thereby distance themselves farther from the sample carrier electrode than the slower ones. From the velocity distribution of the ions there results a location distribution. Not until after a short scattering time is a homogeneous acceleration field suddenly switched on, i.e. a field with linearly increasing acceleration potential, and the ions are accelerated through the field. The faster ions are farther away from the sample carrier electrode, however, thus at a somewhat lesser initial potential for the acceleration, which gives them a somewhat lesser final speed for the drift path of the time-of-flight spectrometer than the initially slower ions. With correct selection of the time delay (time lag) for employing the acceleration, the initially slower but after acceleration faster ions can catch up again with the initially faster but after acceleration slower ions exactly at the detector. Thus ions of the same mass are focused with respect to the time of flight in first order at the site of the detector. It thereby plays no role whether the ions are formed during the laser light pulse or only after this point in time in the expanding cloud through ion-molecule reactions, as long as this formation takes place in the period before switching on of the acceleration potential. Since the velocity of the molecules practically does not change through the ion-molecule reactions, also focused by means of this method are ions which fly off as initially fast neutral molecules, and were ionized only later, but still before employment of the electrical acceleration, however. For reasons of good time resolution, time-of-flight mass spectrometers are operated with high acceleration voltages of up to about 30 kilovolt. To switch on the acceleration field, one can either switch over the potential of the sample carrier electrode or the potential of the interelectrode. The voltage swing is thereby dependent upon the distance of the interelectrode from the sample carrier since for the same acceleration field the lesser the electrode spacing, the smaller the voltage difference. Understood here by “high” potential, or by “high voltage” is a potential that respectively repels and accelerates the ions. It can be advantageous to install the interim electrode as close as possible in front of the sample carrier electrode and to use a small voltage swing since the quick switching of the voltage is all the more easier to accomplish technically and all the more economical the lesser the voltage swing is. There is however a lower limit for this spacing. The limit presents itself in that the fastest ions must always be located in the field-free space during the time lag. Since the fastest ions usually have velocities of about 1500 m/s (meters per second) and the maximal time lag is indicated in literature as about one microsecond, the maximal flight path of the fastest ions in the field-free lag time amounts to about 1.5 millimeters. In practice, a spacing apart of the interelectrode from the sample carrier electrode is usually selected of about 2 to 10 millimeters.

With all mass spectrometers, fragmentation plays a role which is not negligible. Understood by fragmentation is the break up or splitting of a molecule into a multiplicity of daughter molecules. There are essentially two processes of fragmentation or respectively splitting. On the one hand, scattering at residual molecules in the not perfectly evacuated flight tube can split the molecules at their weakest bonds. The actual pulse transmission is thereby usually small, whereby the flight trajectory of the molecules is substantially maintained. The second important fragmentation process is the spontaneous disintegration of large (metastable) molecules into smaller fragmentation products. The high inner excitation energy comes from the ionization process, in which a great inelastic scattering at the matrix molecules can heighten the inner excitation energy of a molecule. Fragmentation of heavy molecules through nearly elastic scattering is characterized through the obtaining of the energy as well as of the mass:

$$\begin{matrix}{E}_{kin} = {E}_{{kin}^{1}} + {E}_{{kin}^{2}} & ( iv ) \\ eU = \frac{1}{2} {mv}^{2} = \frac{1}{2} {m}_{1} {v}_{1}^{2} = \frac{1}{2} {m}_{2} {v}_{2}^{2} & ( v ) \\ m = {m}_{1} + {m}_{2} & ( vi )\end{matrix}$$

wherein Eₖᵢₙ is the kinetic energy, m the mass of the molecules, and U the potential difference of the accelerating electrode to the grounded electrode. The velocities for small momentum transfers change only insignificantly on the velocity scales of the time-of-flight mass spectrometer, i.e. it applies approximately:
v≅v₁≅v₂ (vii)

Thus the motion trajectory of the molecules, or respectively of their fragmentation products remains substantially the same. The fragmentations differ furthermore also by the location where they occur. On the one hand, the fragmentation can take place within the ion source. In this case, one speaks of a so-called in-source decay (ISD). The ISD takes place already before the acceleration of the molecules in the E-field, whereby the fragmentation can take place very near the surface of the ion source, so that the ions obtain the same properties as their ISD decay products. With so-called post-source decay (PSD), the decay takes place after the ions have already left the ion source, i.e. in the drift path. The most important fragmentations of molecules M into decay products for the ToF mass spectrometers are, for instance:
M⁺=M₁⁺+M₂ (viii)
M²⁺=M₁⁺M₂⁺ (ix)
M²⁺=M₁²⁺+M₂ (x)

Even without the effect of fragmentation, the ions already have a certain range of energy distribution when they leave the ion source. This distribution limits the mass resolution of the time-of-flight mass spectrometers. By means of reflectors, the dispersion range of the initial energy of the molecules can be significantly reduced. With the reflectors a mass resolution of up to >10000 can be achieved with a time-of-flight mass spectrometer. Ions with the same mass but higher kinetic energy Eₖᵢₙ and thus higher velocity fly lower in the reflector, and have therefore a longer flight path in the reflector. It can be shown that the total time of flight of ions with the same mass but different kinetic energies inside the reflector is the same, whereby they thus reach the detector at the same time. Ions from an ion source have neither exactly the same starting times nor exactly the same kinetic energies. Very diverse time-of-flight mass spectrometer configurations have been developed to compensate for differences which arise through this effect. A so-called reflectron is an ionic-optical device in which ions in a time-of-flight mass spectrometer pass through a mirror or reflector, their direction of flight being reversed. A reflectron with linear field (linear-field reflectron) permits ions with higher kinetic energy to penetrate deeper into the reflectron than ions with lower kinetic energy. Ions which penetrate deeper into the reflectron need correspondingly longer until they return to the detector. Thus for a multiplicity of ions with a certain mass-to-charge ratio but with different kinetic energy, a reflectron will reduce the amplitude of distribution in the times of flight, and thus increase the resolution of the time-of-flight mass spectrometer. A reflectron with curved or non-linear field ensures that the ideal detector position of a ToF mass spectrometer does not differ for different mass-to-charge ratios. This likewise creates an improved resolution for a ToF mass spectrometer. In 1973 B. A. Mamyrin presented a new reflectron, which has perhaps proven to be the most important development in ToF mass spectrometers in recent years. The reflectron consists of an ion mirror, which <has> a series of lattices/lenses in either a single-stage configuration with two electrodes or a double-stage configuration with three electrodes. In most cases there is an offset-angle between the primary drift tube to a second field-free drift tube. To obtain a maximal passage with minimal divergence of an ion packet, the ion detector is aligned in the flight tube axis at the end of the second flight tube. This development has proven to be extraordinarily important for time-of-flight mass spectrometers even though field distortions and ion-single scattering or ion-multiple scattering becomes possible owing to the reflector. Mass spectrometers based on reflectrons are moreover usually more expensive since they require an additional ionic-optical reflection structure (“mirror”), a second detector, and an additional, controllable voltage supply.

The above-mentioned state-of-the-art for conventional time-of-flight mass spectrometers presents many difficulties and drawbacks in operation, during which the spatial distribution and the velocity distribution of the extracted ions must be corrected using very complicated and technically demanding techniques such as e.g. time lag focusing, extraction pulse shaping, reflectron techniques, etc. The aim of all these techniques is always a better spectral resolution. In contrast to the relatively slow ISD fragments, the PSD fragments can be distinguished by the state of the art only with reflectrons, since with linear time-of-flight mass spectrometers the PSD fragments arrive at the detector at the same time as the original ions whose decay products they are. The standard approach uses a deflector, i.e. a deflection device, based on electromagnetic fields (electrostatic or magnetostatic) in the evacuated flight tube and/or near the detector of the time-of-flight mass spectrometer in order to deflect the charged components. Thus the time of flight(=mass)-spectrum of the neutral and charged components can be measured jointly, as well as also the spectrum of just the uncharged components. Reflectrons are also used in the state of the art to separate the charged and neutral components. As mentioned, the reflectron is a common linear time-of-flight mass spectrometer with an additional electrostatic mirror near the detector with linear field (linear-field reflectron) and an additional detector at the end of the flight path of the reflected ions. Before admission into the reflector, the fragmented ions and their molecular predecessors have the same velocity. After exit from the reflectron, the fragmented ions and their molecular predecessors have the same velocity; the fragmented ions are spatially and temporally ahead of the unfragmented ions, however. The neutral fragments pass the reflectron without interacting with the reflectron, and can be detected with a special detector. This also applies to the linear operational mode of the time-of-flight mass spectrometer. As is easy to see, the big drawback of the reflectron is its complicated construction. Moreover heavy ions must be reflected with a correspondingly great electric field, which significantly increases the risk of field-induced fragmentation.

It is an object of this invention to propose time-of-flight mass spectrometers (ToF-MS) for analysis of ionized substances, which do not have the drawbacks described above. In particular, selective measurement of charged or respectively neutral particles should be possible without a larger resolution gage and/or a lesser sensitivity of the time-of-flight mass spectrometer resulting through the selection.

According to the present invention, these objects are achieved in particular through the elements of the independent claims. Further advantageous embodiments follow moreover from the dependent claims and from the description.

In particular, these objects are achieved in that, for time-of-flight mass spectrometric analysis of substances from an ion source, the ionized substances are accelerated by means of an electric field of an extractor module, are focused on a focusing axis by means of at least one ion lens of the extractor module, reach a detector via a drift path, and are detected by means of the detector, for a first measurement the ionized substances being deflected by a deflector from the detector surface of the detector, while the focusing axis is centered on the detector surface, neutral components of the substance being measured, and, for a second measurement, the extractor module being moved relative to the detector, so that the focusing axis comes to be situated outside the detector surface in such a way that the neutral fragments of the substance do not impinge the detector surface, and the ionized substance is deflected on the detector surface by means of the deflectors, the ionized substances being measured. The mass resolution is not influenced in any way by the method according to the invention. With the method according to the invention, three different spectra can thus be measured: 1. the spectrum of the neutral and charged components and fragments of the accelerated substance, 2. the spectrum of just the neutral components and fragments of the accelerated substance and 3. the spectrum of just the charged components and fragments of the accelerated substance. The independent measurement of the three spectra, the measuring errors being able to be minimized through the independent control measurement, is not possible in this way in this simple configuration in the state of the art.

In an embodiment variant, the detector surface corresponds to the focusing surface of the ion source projected by means of the at least one ion lens. This embodiment variant has the advantage, among others, that the impinging ions are able to be detected in the focusing surface only, i.e. only those which actually should be detected. No outsider ions hit the detector surface, error probability being significantly decreased.

In a further embodiment variant, the deflector is located as close as possible to the extraction module, so that a deflection angle of the ionized substance becomes minimal for detection in the second position (mode 3). This embodiment variant has the advantage that only minimal electric fields are required for the deflection, and moreover only a minimal field-induced fragmentation of the ions therefore results.

In a still further embodiment variant, the deflector is located as close as possible to the detector. This embodiment variant has the advantage that the energy dispersion, which is caused by the deflection field, results only to a minimal degree in a lateral shift of the ions on the detector surface. An almost mass-independent detection efficiency is thereby achieved.

In a further embodiment variant, substance molecules on the sample carrier are incorporated into a crystal layer of a low molecular matrix substance, the substance being ionized by means of a module by matrix-assisted laser desorption. This embodiment variant has the advantage, among others, that even tiny amounts of the analyte substance can be ionized and analyzed.

In still another embodiment variant, the extractor module comprises a module for time-delayed focusing (time-lag focusing), whereby different desorption energies of the ionized substance are able to be compensated. This embodiment variant has the advantage, among others, that the mass resolution can be further improved.

It should be stated here that besides the method according to the invention, the present invention also relates to a system for carrying out this method.

Embodiment variants of the present invention will be described in the following with reference to examples. The examples of the embodiments are illustrated by the following attached figures:

### BRIEF SUMMARY OF THE DRAWINGS

FIG. 1 shows a block diagram, presenting schematically a view of a time-of-flight mass spectrometer 1 of the state of the art. The time-of-flight mass spectrometer 1 comprises an ion source 2, an extractor module 3 for acceleration and for focusing the ionized substance on a focusing axis 6, a deflector 4 for deflecting the ionized substances as well as a detector 5 for detecting the ionized substances.

FIG. 2 shows a block diagram, likewise presenting schematically a view of a time-of-flight mass spectrometer 1 of the state of the art. Various fragmentation regions which are to be taken into account for the time-of-flight mass spectrometer I are designated by the reference numerals 61, 62 and 63.

FIG. 3 shows a block diagram illustrating schematically a view of a time-of-flight mass spectrometer 1 according to the invention. Typical trajectories are indicated, on the one hand, by the ionization trajectory 64, which is given through the initial velocity of the ions at the exit from the ion source 2 and the electrostatic acceleration field of the acceleration module 31, on the other hand by the focusing trajectory 65 which is given in addition through the focusing field of the ion lens 32.

FIG. 4 shows a block diagram illustrating schematically a view of a time-of-flight mass spectrometer 1 according to the invention. In addition to the trajectories 64/65 marked in FIG. 3, the trajectories 66 or respectively 67 refer to trajectories with switched-on deflector field 41 for charged or respectively neutral components or fragments of the accelerated substance.

FIG. 5 shows a block diagram, likewise illustrating schematically a view of a time-of-flight mass spectrometer 1 according to the invention. In addition to the trajectories 64/65 marked in FIG. 3, the trajectories 68 or respectively 69 refer to trajectories with switched-on deflector field 41 for charged or respectively neutral components or fragments of the accelerated substance. The extractor module 3 has been rotated here by the angle α.

### DETAILED DESCRIPTION OF THE INVENTION

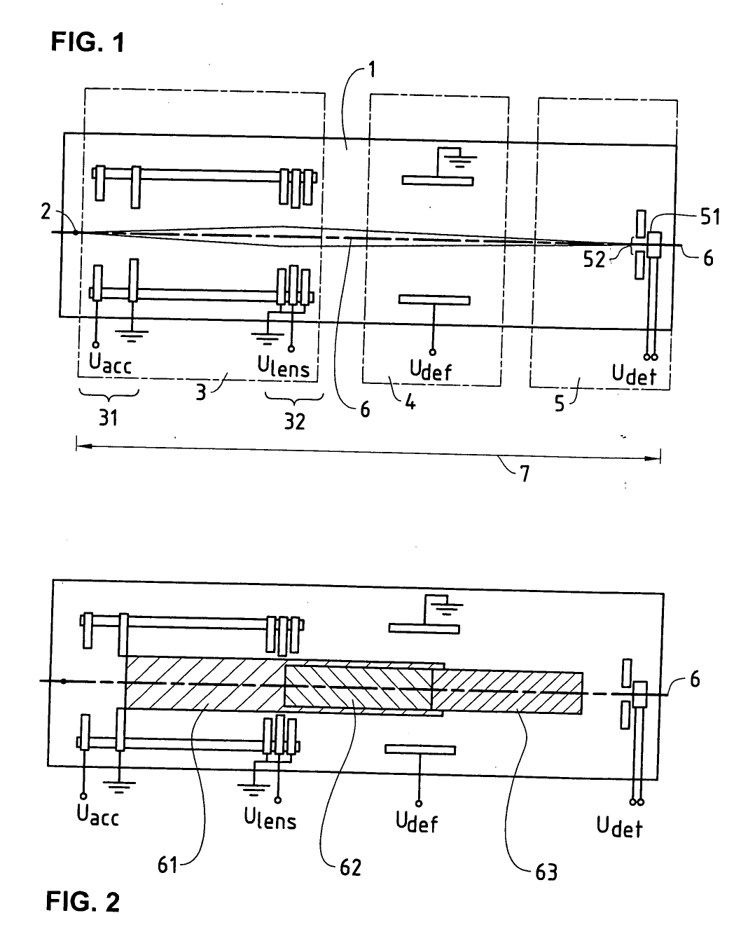

FIG. 1 illustrates a time-of-flight mass spectrometer 1 or respectively a method for time-of-flight mass spectrometric analysis of substances from an ion source 2, as they can be used in achieving the invention. Same reference numerals in the figures designate same elements. In this embodiment example, the time-of-flight mass spectrometer 1 comprises an ion source 2, an extractor module 3 for accelerating the ionized substances by means of an electric field and for focusing the ionized substance on a focusing axis 6 by means of at least one ion lens 32, a deflector 4 for deflecting the ionized substances, a drift path 7 as well as a detector 5 for detecting the ionized substances. The extractor module 3 can comprise e.g. an ionization module 33, an acceleration module 31, one or more ion lenses 32 and a high voltage supply module. The ionization can be carried out by means of the ionization module 33 of the extractor module 3 e.g. through thermal ionization (e.g. of a gas or vapor), spark source ionization (spark source), electron impact (EI), photoionization (PI), chemical ionization (CI), field ionization (FI), field desorption (FD), multiphoton ionization (MPI), ionization through bombardment of fast atoms (Fast Atom Bombardment: FAB), plasma desorption mass spectrometry (PDMS), secondary ion mass spectrometry (SIMS), thermospray method (TS), infrared laser desorption (IRLD), matrix-assisted laser desorption and ionization (MALDI), electrospray ionization (ESI), nanoelectrospray ionization (NESI), chemical ionization at normal pressure (Atmospheric Pressure Chemical Ionization: APCI), etc. Without having any limiting effect whatsoever upon the inventive concept, an ionization module 33 with matrix-assisted laser desorption and ionization (MALDI) was selected for this example, in which the sample is irradiated on the sample carrier using a pulsed laser beam. For this purpose, the substance molecules are applied on the sample carrier beforehand in a crystal layer of a low molecular matrix substance. The matrix substance can have photoactive components such as e.g. gentisic acid C₇H₆O₄ (2.5-dihydroxybenzoic acid: 2.5-DHBA), 4-HCCA (alpha-cyano-4-hydroxycinnamic acid) or dithranol (anthralin). The energy, absorbed from the sample, of the laser beam brings about a fast heating up and expansion of the sample. The fast heating up and expansion results in a vapor cloud (or material jet) expanding in the vacuum, which cloud, through its expansion, accelerates not only the molecules and ions of the matrix substance, but also, through viscous entrainment, the molecules and ions of the analyte substance. Depending upon the application, used as laser can be e.g. nitrogen laser (337 nm) or quality controlled neodymium-yttrium-aluminum-garnet (Nd-YAG), laser frequency tripled to 354 nm or frequency quadrupled to 266 nm, which are suitable e.g. for MALDI techniques, which irradiate e.g. at 20 mJcm⁻². For instance, for protein analysis, it can also make sense to select lasers with greater wavelength, since greater wavelengths are absorbed more slowly by the matrix substance. If the cloud expands in the field-free space, the ions thus reach mid-range initial velocities v₀ of about 700 meters per second. The velocities are thereby largely independent of the mass of the ions, but have a great velocity dispersion ranging from about 200 up to 2000 meters per second. It is to be assumed that the neutral molecules also have these velocities. The duration of the laser pulse is typically in the nanoseconds range. The extractor module 3 can comprise a module for time lag focusing (TLF), whereby the dispersion of the different desorption energies of the ionized substance can be reduced. In general it can be said that it is advantageous for the ions to be generated within a small ionization volume with as minimal a velocity distribution or respectively dispersion of the initial velocities v₀ as possible in order to achieve as good a mass resolution as possible. The mass precision is also normally indicated in ppm (parts per million) as in the following. The extractor module 3 accelerates the ions by means of the acceleration module 31 and focuses them along the focusing axis 6 by means of the one or more ion lenses 32. The extractor module 3 can be advantageously of rotational symmetrical design, the rotational axis being perpendicular to the x/y direction of the plane of the ion source 2. The rotational axis should be perpendicular to the plane of the ion axis since otherwise the extraction volume changes with the ionization volume with increasing rotation, which can lead to a smaller amount of extracted and focused ionized substance. The actual extraction volume (in dependence upon the ionization volume) is given by way of the projection characteristics of the ion lenses 32 and of the aperture 52 of the detector 5.

The deflector 4 can comprise e.g. an electromagnetic module and a high voltage supply module, which acts upon charged particles through an electromagnetic field (electrostatic or magnetic). By means of the electromagnetic module, ions, which e.g. are defocused or not clearly focused by the extractor module 3, can be realigned and/or already aligned ions can be deflected, depending upon the operating mode of the deflector 4. FIG. 2 shows the different regions for PSD fragments in the time-of-flight mass spectrometer 1. All charged PSD fragments, which arise within the region 61, allow themselves, like their original mother molecules, to be focused and also deflected, while the neutral fragments only have the velocity of the mother molecule and no longer allow themselves to be influenced by electromagnetic fields. PSD fragments (charged, as well as neutral), which originate from the region 62 from incidents of decay, are still focused by means of the ion lenses 32 only indirectly via their mother molecules. PSD fragments from the region 63, finally, are also no longer captured directly by the deflector 4. Nevertheless the trajectories of all PSD fragments from the areas 62 and 63 as well as of their original molecules are situated normally very close to one another, or are identical, i.e. only able to be differentiated with difficulty. The detector 5 is made up of a spatial aperture 52, or respectively shutter, and of a module for ion detection, with temporal resolution, such as e.g. MCP (Microchannel Plates). Also conceivable for detection, however, is a module based on electron multiplier technology. Electron multipliers, which are made up of a multiplicity of layers of charged dynodes, can be advantageous for certain applications, for instance, since, among other things, they have proven to be stable with high ion currents. The detector 5 comprises a detector surface 51, corresponding substantially to the focal surface of the ion source 2 projected through the at least one ion lens 32 (i.e. through the focusing lens). The extractor module 3 is displaceably disposed relative to the detector 5, in a first position 11 the focusing axis being able to be centered on the detector surface 51, while, in a second position 12, the focusing axis 6 is positionable outside the detector surface 51. As an embodiment variant, it can be advantageous for the deflector 4 to be located as close as possible to the extraction module 3, so that the deflection angle of the ions is minimal in mode 3. Only minimal electric fields are thereby needed for the deflection, and moreover only a minimal field-induced fragmentation of the ions thereby results. It can likewise be advantageous for the deflector 4 to be located as close as possible to the detector 5, so that the energy dispersion, which is caused by the deflection field, causes only to a minimal extent a lateral displacement of the ions on the detection surface 51, whereby a detection efficiency almost independent of mass is able to be achieved.

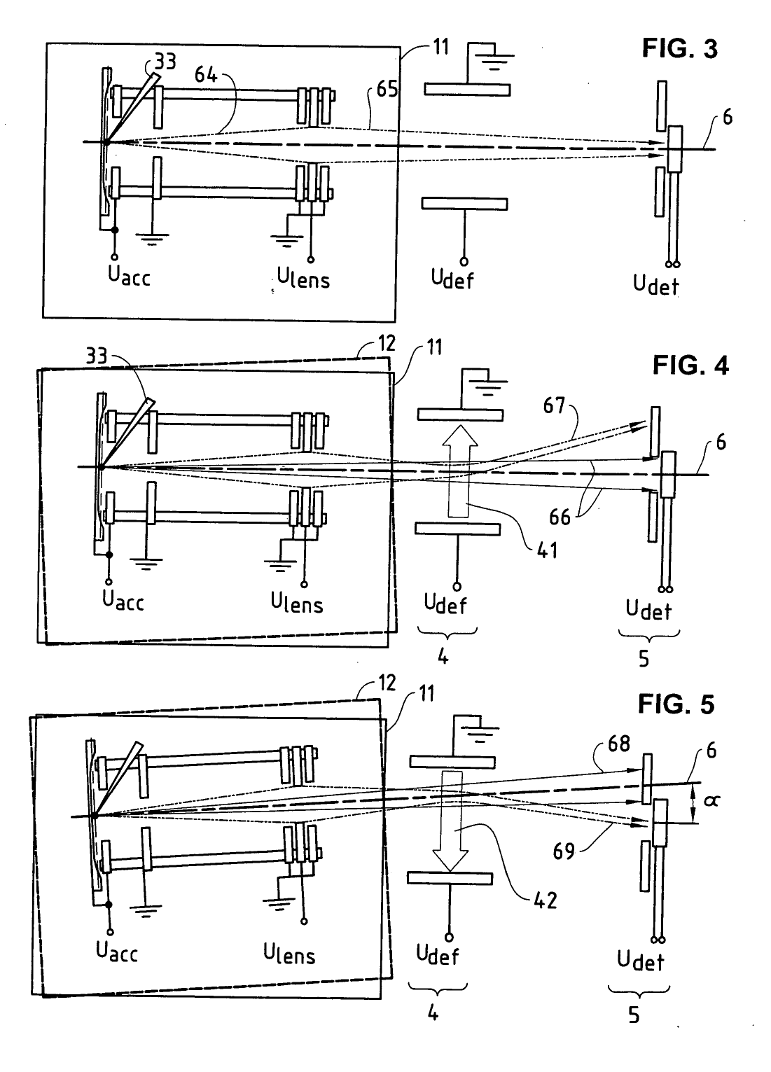

With the time-of-flight mass spectrometer 1 according to the invention, three different operational modes are possible by means of this configuration. In the basic setting or mode 1, the extractor module 3 in situated in the first position 11, and the ionized and accelerated substance is not deflected by the deflector 4. FIG. 3 shows the time-of-flight mass spectrometer 1 according to the invention in operational mode 1. The focusing axis 6 of the extractor module 3 is aimed at the detector surface 51. All accelerated particles, i.e. neutral and charged components as well as neutral and/or charged fragments, are thereby detected in mode 1 by the detector 5 in an optimal way. Neutral fragments, which originate from incidents of decay in or before the acceleration segment, are suppressed in a natural way through the large solid angle compared with neutral fragments which have arise during the drift segment and were therefore focused on the focusing axis 6. FIG. 4 illustrates operating mode 2 for detection of neutral components. In mode 2, the focusing axis 6 of the extractor module 3 is likewise aimed at the detector surface 51, in order to focus the accelerated substance optimally on the detector surface 51. In operating mode 2, however, the deflector 4 is activated, and charged (ionized) substance is deflected from the detector 5 by means of e.g. electrostatic deflection plates which generate an electric deflector field 41. The electric deflector field 41 can be generated e.g. perpendicular to the focusing axis 6. The electric field strength is selected at such a strength that the charged particles no longer hit the detector aperture 52. FIG. 5, finally, illustrates operating mode 3 for detection of charged, accelerated components. In mode 3, the extractor module 3 is brought into position 12 by the angle α relative to the detector 5. The angle α a is selected such that neutral accelerated components no longer hit the detector opening 52. Since the focusing angle 6 is likewise shifted thereby by the angle α, the charged components also do not hit the detector aperture anymore. Now, in mode 3, the deflector 5 is also activated, however in such a way that the charged particles are now centered on the detector surface 51, in order to detect the charged particles in an optimal way. As mentioned above, it can be advantageous for the deflector 4 to be located as close as possible to the extraction module 3, so that the deflection angle of the ions in mode 3 is minimal. Only minimal electric fields are thereby necessary for the deflection, and also only a minimal field-induced fragmentation of the ions thereby results. It can also be advantageous for the deflector 4 to be located as close as possible to the detector 5, so that the energy dispersion, which is caused by the deflection field, causes only to a minimal extent a lateral shift of the ions on the detector surface 51, whereby an almost mass-independent detection efficiency can be achieved. It is therefore important, for operating mode 3, for the electric field strength of the deflector 4 to be carefully gaged. Uncharged primary particles as well as neutral (uncharged) fragments are not affected by the field, and are no longer detected in position 12 of the extractor 3.

List of Reference Numerals

1 time-of-flight mass spectrometer
   11 first position of the extractor module
   12 second position of the extractor module
2 ion source
3 extractor module
   31 acceleration module
   32 ion lens
   33 ionization module
4 deflector
   41 deflector field
   42 deflector field
5 detector
   51 detector surface
   52 aperture of the detector
6 focusing axis
   61/62/63 fragmentation regions
   64 ionization trajectory
   65 focusing trajectory
   66 trajectory for charged (extractor position 11)
   67 trajectory for neutral (extractor position 11)
   68 trajectory for charged (extractor position 12)
   69 trajectory for neutral (Extraktorposition 12)
drift path
α angle between raised area and axial direction

1. Method for time-of-flight mass spectrometric analysis of substances from an ion source, the ionized substances being accelerated by means of an electric field of an extractor module, being focused on a focusing axis by means of at least one ion lens of the extractor module, reaching a detector via a drift path, and being detected by means of the detector wherein
for a first measurement, the focusing axis is centered on the detector surface and the ionized substances are deflected by a deflector from the detector surface of the detector, neutral components of the substance being measured,
for a second measurement, the extractor module is moved relative to the detector, so that the focusing axis comes to lie outside the detector surface such that the neutral fragments of the substance do not impinge the detector surface, and
the ionized substance is deflected on the detector surface by means of the deflector, the ionized substances being measured.

2. Method according to claim 1, wherein die detector surface corresponds to the focal surface of the ion source projected by means of the at least one ion lens.

3. Method according to claim 1, wherein the deflector is disposed as close as possible to the extraction module, so that for detection in the second position a deflection angle of the ionized substance becomes minimal.

4. Method according to claim 1, wherein the deflector is disposed as close as possible to the detector.

5. Method according to claim 1, wherein substance molecules on the sample carrier are incorporated in a crystal layer of a low molecular matrix substance, the substance being ionized by matrix-assisted laser desorption by means of a module.

6. Method according to claim 1, wherein the ionized substance in the extractor module is accelerated in a time-delayed way by means of a time-lag-focusing module, different desorption energies of the ionized substance being compensated.

7. Method according to claim 6, wherein substance molecules on the sample carrier are incorporated in a crystal layer of a low molecular matrix substance, the substance being ionized by matrix-assisted laser desorption by means of a module.

8. Method according to claim 6, wherein the ionized substance in the extractor module is accelerated in a time-delayed way by means of a time-lag-focusing module, different desorption energies of the ionized substance being compensated.
